(19) United States
(12) Patent Application Publication
(10) Pub. No.: US 2002/0026419 A1
(43) Pub. Date: Feb. 28, 2002

(54) Apparatus and method for populating a portable smart device

(75) Inventors: L. Michael Maritzen, Fremont, CA (US); Harold A. Ludtke, San Jose, CA (US); Tomitaka Tadafusa, San Jose, CA (US)

Correspondence Address: John P. O'Banion, O'BANION & RITCHEY LLP, Suitr 1550, 400 capitol Mall, Sacramento, CA, 95814, US

(73) Assignee: SONY ELECTRONICS, INC.

(21) Appl. No.: 09/737,277

(22) Filed: Dec. 12, 2000

Related U.S. Application Data
(60) Provisional application No. 60/227,679, filed on Aug. 24, 2000.

(51) Int. Cl. G06F 17/60

(52) U.S. Cl. 705/41

(57) ABSTRACT

An agent based electronic commerce system and method for automatically populating a device such as a digital wallet with bank, credit or other consumer information. The system includes a data-transaction device that is capable of directly or indirectly connecting with a transaction and information processing clearing house. The transaction and information processing clearing house serves as an information repository as well as facilitating information gathering for selected user accounts. The user can automatically populate numerous devices in various locations with updated information without intervention. In one embodiment the user can conduct electronic commerce transactions automatically or singly with a financial processing mechanism associated with the transaction and information processing clearing house.

### CROSS-REFERENCE TO RELATED APPLICATIONS

This application claims priority from U.S. Provisional Application Ser. No. 60/227,679 filed on Aug. 24, 2000 and incorporated herein by reference.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention pertains generally to electronic commerce systems and devices and, more particularly, to the secure automated distribution of information individualized to a particular consumer over a network.

2. Description of the Background Art

Interlinked computer networks, such as the world wide web (e.g., the Internet), are being used increasingly for both communication and business transactions. Numerous associated networks are becoming increasingly used for data delivery, such as satellite networks, interactive TV, cable networks, and wireless device networks and the like. The efficiency with which business and personal communications may be exchanged over computer networks is redefining traditional business transactional practices. Point of sale credit or debit money transfer systems, as well as systems for the personal computer, allow a user to conduct transactions without the use of currency, bank drafts or checks.

Access to such networks has been improved with the advent of portable computing devices including wireless telephones, personal organizers, digital wallets and laptop computers. These devices have become popular with a large segment of the population and enjoy widespread use. However, the usefulness of such devices depends on the diligence of the user in updating information.

One constraint with hand held and pocket sized devices is the difficulty inputting information in the device. The reduced size of these devices can only be achieved by reducing the size of the keyboard or eliminating the keyboard altogether. Another approach has been to use the display screen as the keyboard using a stylus and handwriting recognition software. This requires the user to learn a special input alphabet or shorthand symbols which takes time and effort and therefore the device is not immediately useful to a new user. The device may be completely useless to the impatient user who is unwilling to learn the symbols.

The initial transfer of information to the device can be quite difficult and time-consuming using a stylus or a very small keyboard. This limits the effective and efficient transfer of useful information and the type of information that can be placed in a device. Likewise, the user must enter information updates into every device when the information is received. This process must be repeated by the user for every device owned by the user. Accordingly, the loss or damage to such devices can have a substantial impact on the affairs of a user due to the loss of the data and the time required to populate a new device with information.

A second constraint with the hand held or pocket sized device is the lack of a secure system for storage of information on the smart device or the transmission of information between Internet networks. System security and device security are necessary to maintain the integrity of any electronic commerce (e-Commerce) system.

There has been a recent trend to eliminate the use of bank checks and currency by automating certain shopping, banking and credit transactions. Current electronic fund transfer systems may be vulnerable to unauthorized use and fraudulent transactions unless appropriate precautions are taken because an unauthorized user can obtain access to the system without dealing with another individual. Likewise, credit and debit information transmitted through the Internet may be susceptible to interception and misuse. This vulnerability is due primarily to the transmission of personal credit data such as a credit card number over public Internet lines and the storage of a users personal credit data at multiple vendor locations.

Therefore, a need exists for methods of increasing the availability of account and financial information and transaction capability to a user while providing secure network. The present invention satisfies that need, as well as others, and overcomes the deficiencies of previously developed solutions.

### BRIEF SUMMARY OF THE INVENTION

By way of example, and not of limitation, the invention includes a system and method for enabling a user to create and manage ongoing financial relationships and data as well as conduct secure electronic commerce transactions using an agent based “zero click” model.

The preferred embodiment of the invention includes a personal computing device, such as a digital wallet, that has a unique identifier (ID) and is capable of connecting with a transaction and information processing clearing house (TIPCH) by a secure link. The computing device preferably incorporates a security device such as on-card fingerprint recognition technology.

The TIPCH preferably develops and maintains permanent relationships with financial and mortgage institutions, credit providers, department store chains, government entities and the like that will allow direct secure access to their information and account databases. These are referred to as inside vendors. Inside vendors regularly send or allow access to updated information by TIPCH.

The TIPCH will also preferably have the capability of transmitting and receiving information from vendors transmitted over the Internet or telephone lines as individually requested on behalf of particular users. These are referred to as outside vendors. Access to outside vendors may be conducted automatically or manually at the request of the user. Users of the system typically utilize both inside and outside vendors.

The TIPCH also preferably includes an information repository (IR) for each registered user containing pertinent information pertaining to bank accounts, credit accounts, utility and other monthly service accounts, brokerage accounts, mortgage accounts and other essential information selected by the user. The selected account or other information sources are preferably monitored regularly by the TIPCH for updated information. Updated account information from the accounts of inside and outside vendors is maintained in the TIPCH information repository and directly available to the user. The user may also provide the TIPCH with additional updated information from a link to a personal computer or like device.

Strategic relationships with credit providers, banking service providers, brokerage houses, department store chains and the like that are preferably established with the TIPCH. These strategic relationships allow direct transactions between TIPCH and the inside vendor on behalf of the user as well as provide updated account information or alternatively allow TIPCH access to the providers database for updated information. Likewise, the TIPCH will also be capable of acting as a proxy for the user with “outside vendors” that do not have a strategic relationship with TIPCH by using user defined passwords etc. to access information from the outside vendor.

For transactions, the TIPCH preferably has a financial processing system (FP) which can electronically transfer funds from the user's account to the vendors account. Likewise, for credit transactions, the financial processing system can facilitate the transfer of funds from the users financial institution to the vendors account.

Products purchased that cannot be electronically transmitted to the user may be distributed to the user through a distribution functionality (D) which may include arranging for shipment through third party carriers.

The user will preferably have access to financial and account status information regardless of the type device used to access the system. For example, devices such as smart cellular phones, home personal computers, web-enabled kiosks and personal digital assistants (PDAs) and other financially enabled e-Commerce devices can receive information automatically when linked to the system. The user will have access to relevant information regardless of the type of access including Internet-based, wireless, cable or traditional retail point of sale environment access or of the location of access whether it is at home, business, in-store or mobile. Each device will be automatically populated with the relevant information from TIPCH and therefore the user can know the latest account status and conduct transactions from any one of the many devices at virtually any location. Furthermore, if a device is lost, stolen or destroyed the replacement device can be readily populated with essential information without requiring the user to manually enter all of the information into the device.

Thus the user sets up an account with the network and provides information pertaining to credit accounts, bank accounts, utility accounts and other consumer information to the TIPCH. Each device is preferably registered with TIPCH and is associated in the system with a particular user. Once the user system is established, the TIPCH automatically obtains updated account information for the designated accounts or other information sources. The updates may alternatively be obtained manually on an account-by-account basis as directed by the user.

It is an object of the invention to provide a data transfer and transaction system that is capable of automatically updating consumer information and settling account transactions in a secure network environment without requiring the user to carry cash.

Another object of the invention is to provide a number of fixed and portable data carriers interconnected by a communications network that can provide ready access to consumer financial information at any location.

Another object of the invention is to provide an e-Commerce system that will allow the efficient examination and review of account and financial information without requiring the user to input the data into any storage device.

Another object of the invention is to provide a simplified interface for user interaction that is configured for visual and intellectual consistency regardless of form, usage, or location.

It is a further object of the invention to provide an e-Commerce system including a pocket sized, portable, personal terminal unit, which may be used for handling a wide variety of financial, shopping and other transactions.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a functional block diagram of an automatic information distribution system in accordance with one embodiment of the present invention.

FIG. 2 is a functional block diagram of an inside vendors only embodiment of an automatic information distribution system in accordance with the present invention.

FIG. 3 is a functional block diagram of an outside vendor's only embodiment of an automatic information distribution system in accordance with the present invention.

FIG. 4 is a functional block diagram of an e-Commerce system in accordance with one embodiment of the present invention.

FIG. 5 is a flowchart of an embodiment of a process for registering and verifying the users identity and the device identity prior to automatically populating the device in accordance with the teachings of the present invention.

FIG. 6 is a flowchart of an embodiment of a process for performing automatic and user authorized transactions in accordance with the teachings of the present invention.

### DETAILED DESCRIPTION OF THE INVENTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

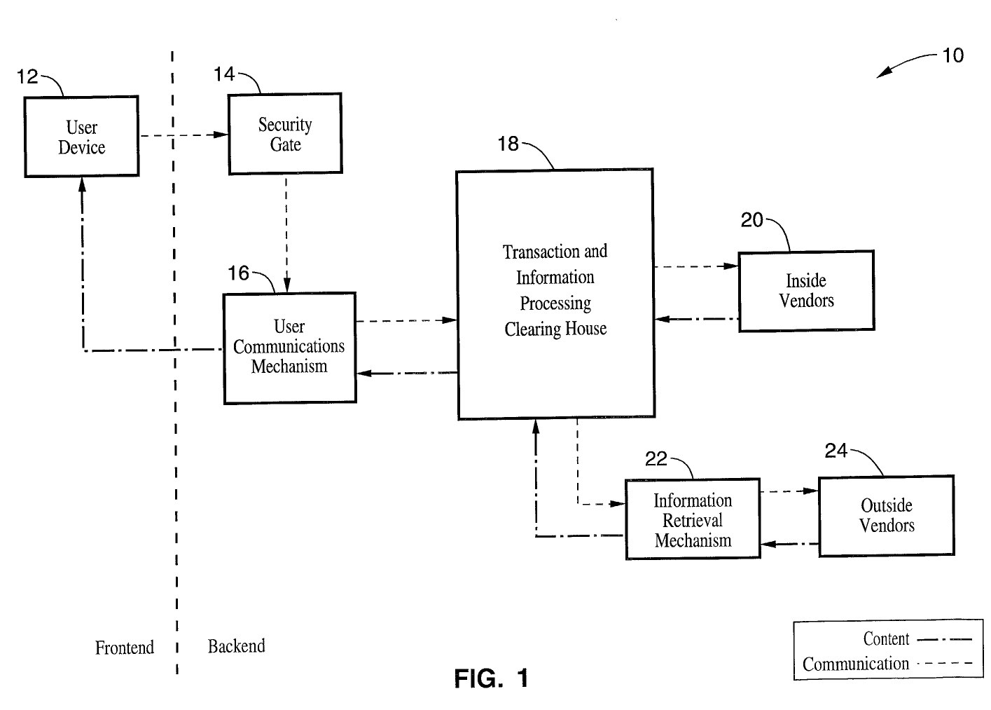

Referring more specifically to the drawings, for illustrative purposes the present invention is embodied in the method and system generally shown in FIG. 1 through FIG. 6, where like reference numbers denote like parts, functions and steps. It will be appreciated that the system may vary as to configuration and as to details of the parts and that the method may vary as to the steps and their sequence without departing from the basic inventive concepts disclosed herein.

The system and method of the present invention enables a user to maintain credit, bank account and other consumer information in a single repository and to receive updated account and other information automatically as well as conduct electronic commerce transactions with any number of computation devices from any location. With this system, lost, stolen or damaged devices as well as new devices can be automatically populated with information at any time.

The following description discusses the invention in the context of Internet and wireless communication networks. However, it is readily apparent that the invention is not limited to these particular networks, and is applicable to any network that is configured to perform a transaction.

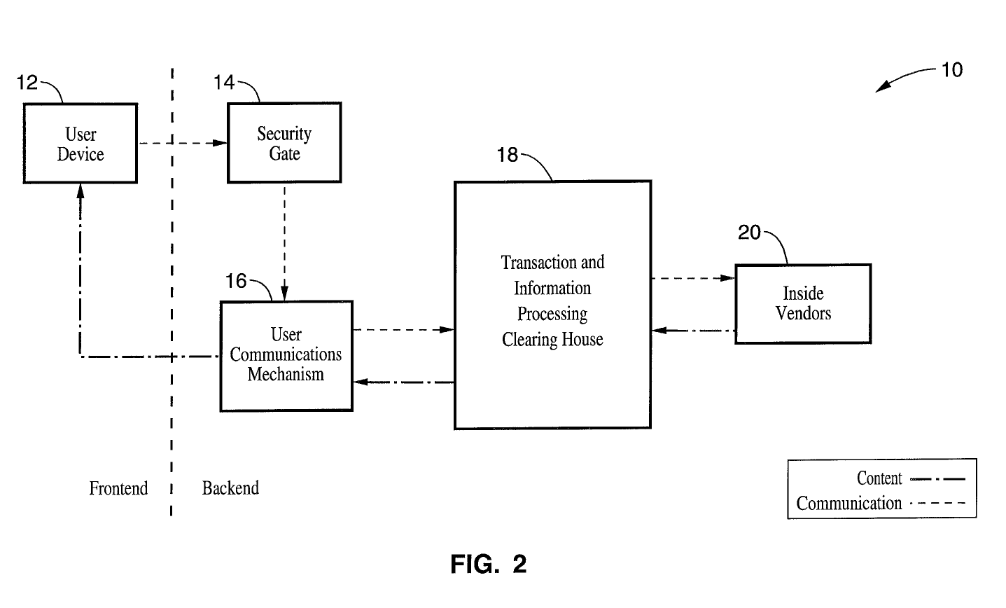

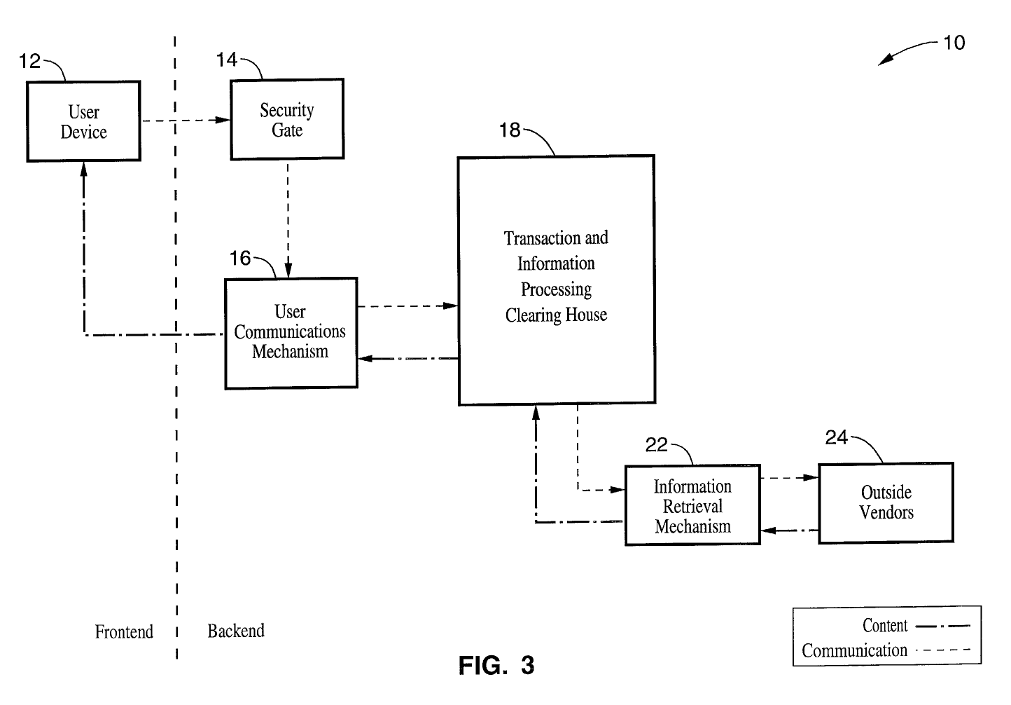

Referring first to FIG. 1, FIG. 2 and FIG. 3, an information distribution and e-Commerce system 10 according to the present invention is shown for providing account and other consumer information automatically to a user. The user preferably connects to and performs transactions with the information distribution and e-Commerce system 10 through a user device such as data-transaction device 12 that preferably has a unique identifier (ID). The system is adapted to accommodate various types of user devices such as portable smart devices including digital wallets, personal computers, laptop computers, smart cellular phones, personal digital assistants as well as stationary devices such as retail point of sale (POS) terminals, web-enabled kiosks, and the like. Data-transaction device 12 preferably has the capability of receiving and displaying transmitted data from a transaction and information clearing house 18 (TIPCH). Alternatively, the device should be capable of permitting an associated device such as a POS terminal to display and transmit data. For example, in one embodiment, a privacy card is used. In an alternative embodiment, a privacy card in conjunction with a digital wallet is used.

The selected device of the user preferably connects through a security gate 14 and user communications mechanism 16 to an agent based, “zero click” system that preferably includes TIPCH 18. Information gathered from inside vendors 20 and optional outside vendors 24 is automatically distributed to the user device 12 from TIPCH 18 when the user enters the system.

Data-transaction device 12 preferably has a transaction functionality as well as a data receipt and storage capability. Data-transaction device 12 is preferably capable of communicating and interfacing directly with TIPCH 18 or alternatively interfacing with a device that is capable of interfacing with TIPCH 18.

Accordingly, data-transaction device 12 may contain wireless data communication, data storage and communication protocols for selectively communicating with outside devices such as a digital wallet described herein, point of sale (POS) terminal or personal computer (PC) and digital televisions (DTV). Communication protocols include those that allow a digital wallet to specify which of several possible data structures to use for a transaction and communication protocols that allow the digital wallet and other devices to securely share data with the data-transaction device. The data-transaction device may represent a single account such as a particular credit card, or it might represent multiple accounts such as a credit card, telephone card and debit card.

Data-transaction device 12 can be configured to function compatibly with existing point of sale terminals at retail locations and provide encoded account information compatible with existing systems such as magnetic stripe and bar codes. A magnetic stripe generator on the data-transaction device can be programmed to represent any account. Additionally, the screen on the data-transaction device can be used to display bar codes that can be scanned by existing POS terminals. Alternatively, the card may also have a smart card chip that functions similarly to standard credit cards. Thus there is a capability to access multiple accounts from a single card, thereby eliminating the need to carry many different credit cards, such as debit and loyalty cards, but still providing the opportunity to use different accounts based on the user's choice.

Furthermore, data-transaction 12 device may include a bar code reading device integrated therein. This feature would allow the user to scan product packaging and add that item to a purchase or an electronic shopping list. In addition, the physical paper trail can be eliminated both for transaction receipts at the stores as well as monthly bills and bill paying on accounts by storing such information and providing access to such information through data-transaction device 12. The automation of transaction record keeping at home can be enhanced as the receipts, bills and bill paying can be maintained on the data-transaction device or a coupled personal computing device.

Data-transaction device 12 preferably includes a security mechanism that can authenticate a user. A variety of verification techniques may be used. For example, data-transaction device 12 may be secured by authenticating the user of the device prior to usage such that if a device is lost or stolen, it is useless in the hands of an unauthorized person. One means of authentication is some form of PIN code entry.

Likewise, lists of devices with account and/or access issues may be maintained. For example, the public key infrastructure (PKI) may be used to verify legitimacy.

Alternately, authentication may be achieved by using more sophisticated technologies such as a biometric solution (e.g., fingerprint recognition). For example, a fingerprint pad and associated logic may be included to secure the device; thus, to access the device, the user would have to touch the fingerprint pad and wait for the logic to determine that the user is authorized to access the device.

Preferably, the user receives a confirmation of registration, which includes a secret PIN code that may be used for the first-time setup procedure for data-transaction device 12. The means of receiving this PIN code may be a secure email message or a standard paper based mail message. The confirmation message may not typically include any of the questions and answers that were used during the sign-up process. Under separate cover, the user may receive the digital wallet with a simple set of instructions for how to personalize and activate the device. The instructions may be on paper, or may include instructions that are presented on the digital wallet screen as the process is carried out. For example, the user turns on the digital wallet (for example, touches the fingerprint recognition pad in order to turn on the power). The device performs its startup procedure, and detects that is has not yet been personalized (i.e. registered with TIPCH 18). Thus, data-transaction device 12 first prompts the user to enter the secret PIN code. If the PIN code entry fails, the user is prompted again. Ideally, the user is given a finite number of chances to enter the data. After the last failure, the device permanently disables itself and thus becomes useless. It may also display a message requesting that the device be returned to an authorized facility. Assuming successful PIN code entry, the user may then be prompted to answer several of the security questions that were entered into the device at the processing center. Some of the questions might require data entry, and others might be constructed as multiple-choice, with both the correct as well as incorrect answers supplied. Assuming successful response to these questions, the user may then be prompted to enter secure personal identification information such as fingerprint data. In one embodiment in which fingerprint data is used, the user is prompted to enter fingerprint data by successively pressing one or more fingers against the recognition pad. The device prompts the user for each fingerprint that must be entered, for example, using a graphical image of a hand with the indicated finger.

The fingerprint data entry process may be performed at least twice, to confirm that the user has entered the correct data (using the correct fingerprint). If confirmation succeeds, the device writes the fingerprint image data into write-once memory, or other memory that is protected from accidental modification. If confirmation fails, the user is prompted to start over with entry. Failure to reliably enter the fingerprint data after a finite number of tries will result in the device permanently disabling itself, and optionally providing an on-screen message to the user to go to a secure processing facility (such as a bank) to complete the process. After successful personalization, the device is then ready to be used for the initial set of services that the user requested during the registration process. Once the device has been initialized for secure transactions, additional services could be downloaded to the device.

In addition, where multiple transaction devices (e.g., a privacy card and a digital wallet) are used, it may be desirable to configure the first device to enable and program the second device in a secure manner. Thus, the means of communication between the first device and the second device may include mutual device verification so that an unauthorized first device may not be used to enable a particular second device that does not belong to the same or authorized user.

Data-transaction device 12, POS terminals and/or TIPCH 18 may function to verify the authenticity of each other. For example, a privacy card and digital wallet may be configured to verify the legitimacy of each other. Similarly, the transaction device may be configured to verify the legitimacy of the POS terminal and/or TIPCH 18.

Security to the system is furthered by a communications security gate 14, which functions to verify and authorize access to the system through an incoming communications mechanism 16. The security gate 14 preferably requires verification of the registration of the user and registration of the particular data-transaction device 12.

The preferred system has a registration process that includes a registration of each data-transaction device 12, as well as providing billing and security information such as name, Social Security Number, mother's maiden name and password. This information is preferably stored locally on the data-transaction device as well as with the transaction and information processing clearing house. The information is preferably encrypted and delivered to TIPCH 18 over a secure connection at the time of registration.

Preferably, TIPCH 18 serves as an information repository and monitors and updates account and consumer information for the accounts identified in the initial setup by the user. For example, a user may have a data-transaction device 12 in the form of a digital wallet. The user may have identified three credit cards, a checking account, a savings account, a mortgage, a brokerage account, an ImageStation account and five monthly services such as electricity, water, gas, cable and cellular phone. TIPCH 18 regularly obtains updated account information and maintains the information in an electronic database for each registrant. Updated information is transmitted to the user when the user accesses TICPH 18. In another embodiment, the TIPCH seeks and obtains updated information when the user and automatically downloads the information to data transaction device 12 when the system is accessed by the user. In still another embodiment, TIPCH 18 maintains only update contact protocols and the user must manually request updates for each account.

TIPCH 18 can store consumer-specific information such as uploaded social security records, passport records, medical and dental providers, DMV records and the like for ready access by the user. In another embodiment, the TIPCH maintains address-book, digital voice mail and e-mail access that can be accessed by the users various data-transaction devices 12. In yet another embodiment, TIPCH 18 may provide information in a form that is compatible with consumer selected personal computer applications such as Quicken, Microsoft Money, TurboTax, Palm Pilot applications and the like.

Referring particularly to FIG. 2, TIPCH 18 preferably develops strategic relationships with information vendors to allow TIPCH 18 direct access to the vendors account database. In another embodiment, the vendors provide updated information to TIPCH directly for each account. These vendors are called inside vendors 20. In the embodiment shown the system only has inside vendors 20.

There are a number of enticements that the inventive system can offer to vendors to establish a relationship with TIPCH 18 to become “inside” vendors. In one embodiment, the inside vendor has restricted access to the client database of the TIPCH. The inside vendor 20 can dispense electronic billings, electronic receipts or electronic reminders through the system automatically to data-transaction device 12 of the user when the user connects with the system. The system can provide cost savings to the inside vendor 20 because costs associated with paper billings, postage and manpower required to prepare, maintain and send the billings are eliminated.

Another incentive to vendors to become inside vendors is the possibility of directing electronic coupons (e-coupons) to system registrants. Pay per use coupons may also be easily and automatically accessed from a variety of resources stored in the data-transaction device and automatically cashed in when purchases are made using the card.

Electronic coupons are another example of eliminating paper (i.e., eliminating paper coupons) by adding value in electronic form. Additional value comes in the form of wider methods of distribution enhancements to the user experience and/or a more efficient processing on the vendor's side. For example, while shopping, an e-coupon stored in the data-transaction device can be used to pinpoint exact items the user wishes to purchase. In addition, at checkout the coupons may be automatically credited without intervention by the user. Alternately, the user may manually convey e-coupons through bar codes or the like by manual selection of the coupons. This causes the bar codes to be presented on the display of the transaction device, which are then scanned by the POS terminal. Check out clerks and administrative personal do not have to manually handle e-coupons so processing is more accurate and efficient for both the retailer and vendor. Because they are digital in nature, e-coupons benefit from flexible distribution opportunities across all forms of media, including: Internet, digital TV/radio broadcast, and packaged recorded media such as audio/computer/DVD recorded on tape or disk and accessed later on playback. By utilizing electronic coupons, real-time tracking usage provides vendors information regarding advertising channels that are returning results as e-coupons typically contain data structures that enable tracking of this information. In addition, electronic catalogs can be downloaded to the transaction device and the user may reference products/services by direct access of the catalog downloaded to the transaction device. The catalogs may also contain electronic coupons which are automatically “Clipped” and added to the user's device for subsequent use during an applicable transaction. Automated shopping lists can be added to simplify the user's shopping experience. In addition, a directory of where things are located in a particular store may be located on the device to simplify the customer's shopping for items in a particular store environment.

An associated incentive for vendors to become inside vendors 20 is the opportunity to conduct direct advertising within a closed network through banner ads or text communications. Through the e-Commerce system of the present invention, data mining and direct marketing services can also be offered to vendors. For example, any type of demographic questionnaire can be created by a vendor and distributed to users of this system while retaining their individual privacy. The data can be collected and returned to the vendor along with the means of identifying the specific target transaction devices that may subsequently receive the appropriate promotional materials. However, the identity of the user is not revealed. Thus, direct marketing is available to vendors even though user identity confidentiality is maintained. Additionally, the e-Commerce system may automatically collect any type of data that can be obtained through use of this system and subsequently sold to third parties. However, preferably, individual privacy is always maintained.

In the embodiment shown in FIG. 3, the vendors do not have a relationship with TIPCH 18. These information vendors are called outside vendors 24. However, account information is accessible from these vendors over the Internet or telephone lines or the like. Typically a password is required for access to outside vendors 24. It will be understood that the information retrieval mechanism 22 is not limited to retrieval of account information only, but can retrieve any accessible data from sources selected by the user.

TIPCH 18 can initiate contact with the outside vendor on behalf of the user, presents a password and obtains updated information that is maintained by TIPCH 18 through information retrieval mechanism 22. In one embodiment, TIPCH 18 regularly accesses updated account information from outside vendors 24. In another embodiment, the user initiates the updates by TIPCH 18 from the outside vendors 24.

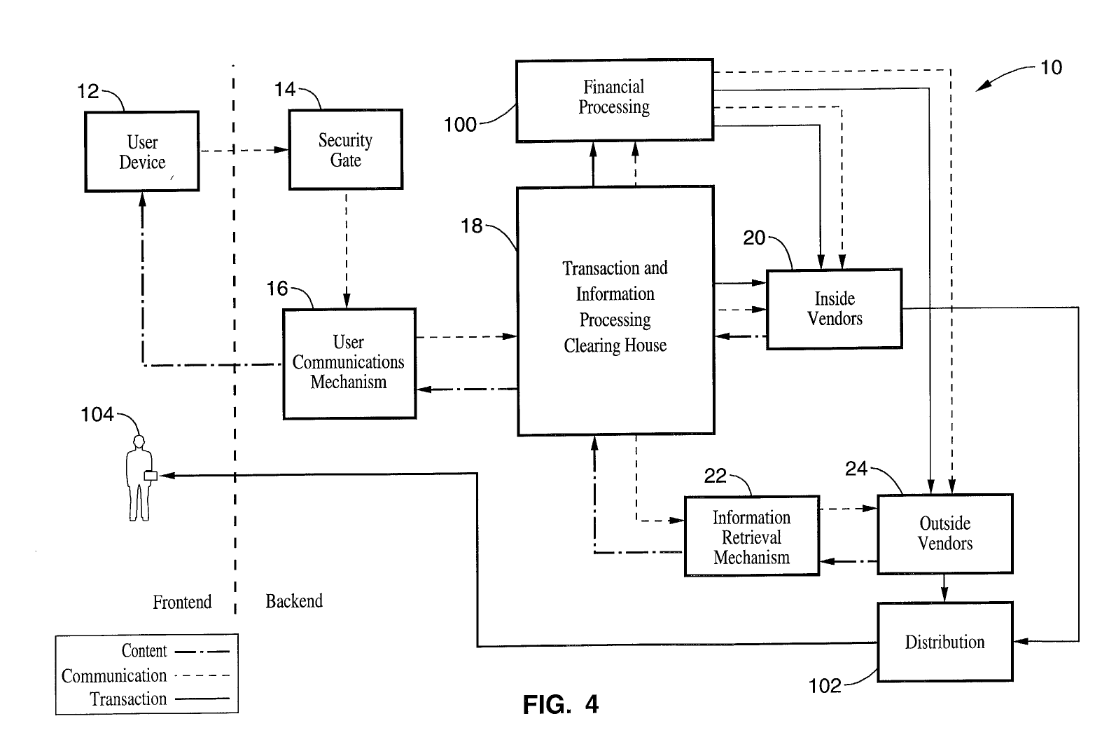

Turning now to FIG. 4, a financial processing system 100 can be included in the invention. In this embodiment, TPCH 18 preferably interfaces to at least one financial processing system 100 (FP) to perform associated financial transactions, such as confirming sufficient funds to perform a transaction or performing the task of transferring funds between the user's account and the vendor's account for each transaction. For example, TIPCH 18 issues transaction authorizations to FP 100 function on behalf of the user over a highly secure channel. FP 100 does not need to have many electronic channels receiving requests for fund transfer, as in a traditional financial processing system. In one embodiment, a highly secure channel is set up between TPCH 18 and FP 100; thus, FP 100 is less vulnerable to spoofing. In an alternative embodiment, the financial processing system 100 is not a separate entity but may be incorporated with TIPCH 18 or other functionalities.

FP 100 may transfer funds to inside vendors 20 or outside vendors 24 through electronic transfer or through conventional credit or banking channels. In one embodiment, the fund transfer to inside and outside vendors is confirmed with an electronic message to the user's data-transaction device 12 through TIPCH 18.

The system described herein also preferably provides a distribution functionality 102 whereby products purchased via the system are distributed. In one embodiment, the distribution functionality 102 is integrated with TIPCH 18 functionality. In an alternative embodiment, a third party may handle the distribution functionality 102. Utilizing either approach, the system ensures user privacy and data security. A variety of distribution systems are contemplated, for example, electronic distribution through a POS terminal coupled to the network, electronic distribution direct to one or more privacy cards and/or digital wallets, or by a physical product distribution. If the product purchased is electronic in nature (e.g., software, content such as digital images, stock purchases, etc.) electronic distribution may be used. In one embodiment of electronic distribution, TIPCH 18 functions as the middleman of the distribution channel. In another embodiment, the shipping status of the purchased item can be tracked and automatically distributed to the user's data-transaction device 12.

In one embodiment of the invention, after registration of the user and the device, the user initiates contact with TIPCH 18 with the data-transaction device 12 as shown in FIG. 4. Security gate 14 authorizes entry to the users database and a secure link is established with the data-transaction device through user communications mechanism 16. Updated account information is automatically transmitted to the data-transaction device 12 of the user. The user then can review account status and direct payment status on selected accounts. TIPCH 18 authorizes a fund transfer by the financial processing system 100 to the designated inside vendor 20 or outside vendor 24. The vendor distributes the goods to user 104 through a distribution network 102 which may include third party commercial carriers, U.S. mail or vendor distributors. The vendor 20, 24 preferably provides a notification of distribution and FP 100 payment to TIPCH and the user's data-transaction device 12.

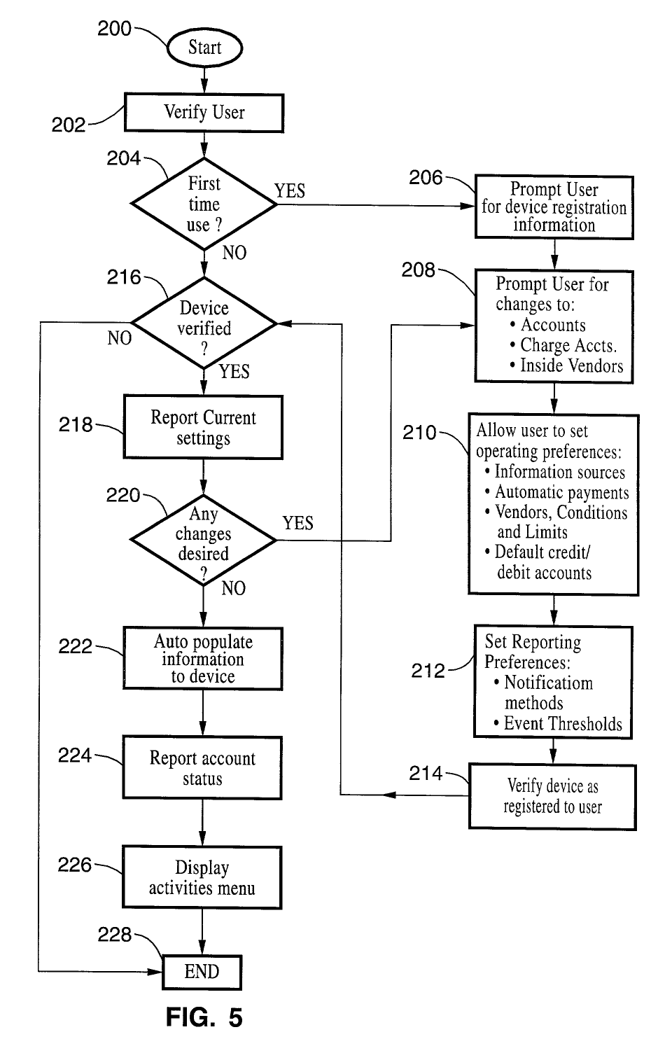

Turning now to FIG. 5 an embodiment of a startup and initiation procedure to the agent based system of the present invention is generally shown. During the initial registration procedure, the user is preferably directed through a series of initiation screens where the user makes a series of preference selections. The user selects a default bank account, a default credit card account, the limits on automatic payment events, brokerage account, mortgage and loan accounts and the like. The user may also add additional accounts to the system after the initial setup procedure as desired by the user. However, it will be seen that the information need only be provided to TIPCH 18 one time regardless of the number of data-transaction devices 12 that are registered.

At block 200 the user activates data-transaction device 12 and establishes a communications link to security gate 14. In one embodiment, security gate 14 in block 202 optionally verifies the user by requesting the entry of a PIN number or other security information from the user. This allows communication with the TIPCH 18 to be established preferably over a secure link. Security gate 14 or alternatively TIPCH 18, verifies the registration of data-transaction device 12 at block 204. If the device has not been registered to a new or existing registered user, the user of data-transaction device 12 is prompted to provide device registration information at block 206. Data-transaction device 12 preferably has a unique identifier that associates the specific device with the account at TIPCH 18.

The user establishes bank accounts, credit accounts and debit accounts that the user desires to use for transactions and monitoring by the system as shown in block 208. Preferably a default debit and credit account are selected for use by TIPCH 18 or FP 100 to complete a transaction with inside vendors 20 and outside vendors 24 when an account is not specified at the time of the transaction.

The user is then preferably prompted to provide account and other information sources that the user desires the system to provide updated information such as brokerage accounts, mortgage accounts, loan accounts, cellular phone carrier, cable or satellite carriers and the like in block 210. In one embodiment the user can designate which accounts are to be paid automatically and the limits of such payments without a prompt from the user. Default credit and debit accounts for automatic payments on selected accounts are also determined. The user may also provide and deposit important information to the system such as passport numbers, dental and health records, regular prescriptions or medications and similar records for future access.

Block 212 illustrates the setting of notification preferences and the thresholds which are to trigger system events.

Once the setup and registration is accomplished, the data-transaction device 12 is considered registered on the system. In block 214, the device will preferably be verified as registered and the registration procedure will be bypassed in future startup events block 216. In one embodiment, the user identification and the device verification must be for the same account or the connection will be terminated.

The current settings are then viewed by the user in block 218 and the user is prompted to make any changes to the settings thereafter in block 220. If no additional changes to the settings are desired, the account information for the selected accounts is automatically sent to the new device. If the device has already been registered, only the updated information is downloaded to the device 12 from TIPCH 18.

At block 224, the latest account status is preferably reported. The complete financial status of the user can be reviewed as well as the non-account information automatically sent to the data-transaction device. The transaction or other activities menu is then displayed at block 226. If no transactions are contemplated by the user, then the session can terminate and the user is logged off of the system.

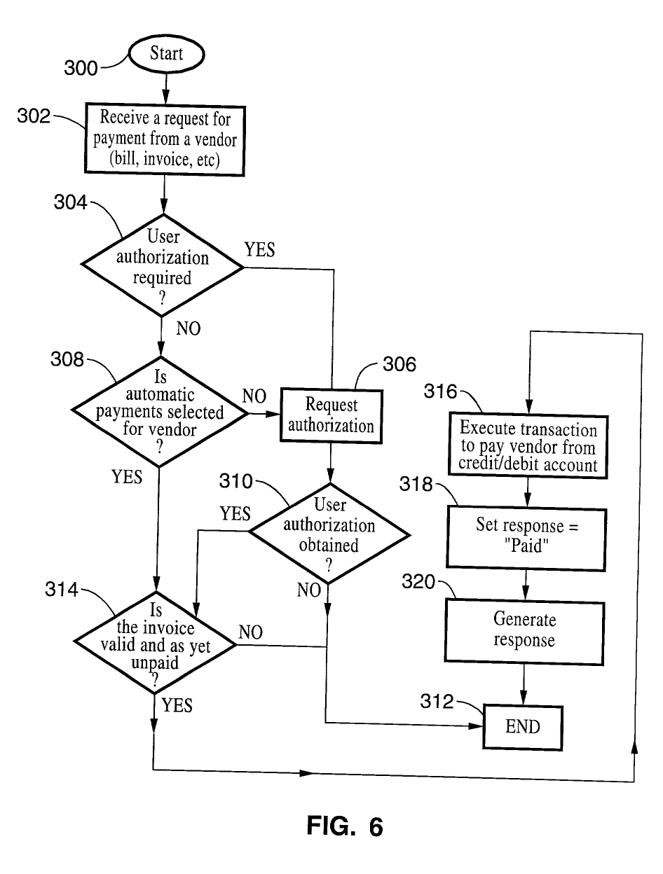

FIG. 6 illustrates an embodiment of a process for the payment of selected electronic billings received by TIPCH 18 from an inside vendor in accordance with the present invention. This process flow assumes that the user had previously determined the accounts for automatic payment at the time of registration and selected a default credit or debit account, date and limits of automatic payment. Note that, instead of automatic payment, other accounts may also have been selected by the user to require user authorization required before payment (e.g., manual authorization required).

At blocks 300 and 302 the process is initiated when a request for payment from an inside vendor 20 is received by the system (e.g., as a result of insider vendor 20 submitting a bill for payment). The system matches the electronic bill with the proper user.

At block 304 the system determines whether the billing is for user authorized payment. If the billing does not require authorization, then the system determines whether automatic payment has been selected for the vendor in block 308. If automatic payment has been selected in block 308, the system determines whether the invoice is valid and unpaid in block 314.

If the billing requires user authorization in block 304, the authorization may be requested by the system by sending a request to the user in block 306. Likewise, if user authorization is not required in block 304 and automatic payment has not been selected in block 308 then the system requests authorization in block 306.

When authorization is requested from the user and obtained from the user in block 310, then the system determines whether the invoice is valid and yet unpaid in block 314. If the authorization has not been obtained, the session ends in block 312. Additionally, if the billing fails to meet any of the conditions for being automatically paid then payment is deferred to allow manual intervention by the user.

Authorized and automatic payments in block 314 are paid through the default credit or debit account in block 316. In an alternative embodiment, the payments are authorized by TIPCH 18 to be made by the financial processing mechanism 100 to be made to the vendor. Once the payment is made and the vendor acknowledges payment in block 318, a response is generated in block 320 to notify the user of the payment. It will be understood that the user may also establish notification conditions and parameters for certain events occurring in the system such as billings exceeding certain limits or multiple billings from the same vendor in the same billing cycle or when default credit or debit limits are exceeded.

Accordingly, it will be seen that this invention provides a simple and effective system of automatically populating a data-transaction device with account and other consumer information through a secure network from an information repository. The system allows multiple devices to be automatically populated at essentially any time at any location. The system also provides a transaction mechanism that eliminates a physical paper trail for both transaction receipts in the stores as well as monthly bills by the use of a data-transaction device.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An information gathering and distribution system, comprising:
a data terminal capable of receiving data; and
a transaction and information clearing house (TIPCH), said TIPCH configured to gather electronic information from a vendor, said TIPCH connected selectively to said data terminal;
wherein said electronic information is automatically transferred to said data terminal when said data terminal is connected to said TIPCH.

2. A system as recited in claim 1, wherein said data terminal is further configured to send electronic signals to said TIPCH.

3. A system as recited in claim 2, said system further comprising a financial transaction processing mechanism associated with said TIPCH, said processing mechanism configured to disperse forms of remuneration to a vendor associated with a transaction authorized by said TIPCH.

4. A system as recited in claim 3, wherein said financial transaction processing mechanism is a financial institution.

5. A system as recited in claim 1, wherein said data terminal further comprises a security mechanism, wherein access to said terminal is restricted to a particular user.

6. A system as recited in claim 1, wherein said transaction and information processing clearing house further comprises a security mechanism, wherein access to said financial and information processing clearing house is restricted to a particular user.

7. A system as recited in claim 1, said system further comprising a secure distribution system for distribution of electronic content to a user from said TIPCH, said TIPCH configured to receive electronic content from a vendor and to provide the electronic content to a user through said secure distribution system.

8. The secure distribution system as recited in claim 7, wherein the TIPCH is configured to provide electronic content to a user by transmitting the electronic content to a users transaction device at the request of the user.

9. The transaction and information clearing house as recited in claim 3, further comprising a distribution channel configured to provide delivery of a product of the transaction.

10. The secure distribution channel as recited in claim 9, further comprising a return system configured to enable the user to return the package to the vendor.

11. An electronic commerce system, comprising:
a data terminal capable of sending and receiving data, said terminal configured to indicate that a transaction is to be performed;
a transaction and information clearing house (TIPCH), said TIPCH configured to gather electronic information from a vendor, said TIPCH connected selectively to said data terminal; said information automatically transferred to said data terminal when said data terminal is connected to said TIPCH, said TIPCH configured to interface with a financial processing system; and
a financial processing system configured to transfer funds from a users account to a vendors account when authorized by a data terminal.

12. A system as recited in claim 11, wherein said transaction and information processing clearing house further comprises a security mechanism, wherein access to said financial and information processing clearing house is restricted to a particular user.

13. A system as recited in claim 11, wherein said data terminal further comprises a security mechanism, wherein access to said data terminal is restricted to a particular user.

14. A system as recited in claim 11, wherein said transaction and information processing clearing house further comprises a distribution system configured to provide delivery of a product of a transaction to a user.

15. The distribution system as recited in claim 14, further comprising a return system configured to enable the user to return the package to the vendor.

16. A method for permitting users to conduct an electronic commerce transaction, the method, comprising:
providing a data-transaction device to a user, the device capable of sending and receiving data, the transaction device having a unique identifier corresponding to the user;
providing a transaction and information clearing house (TIPCH), said TIPCH configured to receive electronic content from a vendor and to provide electronic content to said data-transaction device, said TIPCH maintaining an association between the user and the data-transaction device using the unique device identifier, said TIPCH authorizing a transaction based upon the device identifier, said TIPCH automatically providing said electronic content to said data-transaction device; and
conducting an electronic commerce transaction with a vendor using the data-transaction device.

17. A method recited in claim 16, wherein a set of personal identification information corresponding to he user is obtained and associated with the data-transaction device is obtained and associated to the transaction device upon a registration of the data-transaction device.

18. A transaction and information processing clearing house (TIPCH) for use in an electronic system, comprising:
a secure database identifying accounts corresponding to a particular device identifier;
authorization logic coupled to the secure database configured to authorize access to a user information database;
an information retrieval system wherein consumer account information is retrieved from selected consumer accounts and stored in said user information database; and
an information disbursal system, wherein retrieved information in said user information database is automatically dispensed to a user.
